(19) United States
(12) Patent Application Publication
(10) Pub. No.: US 2006/0133611 A1
(43) Pub. Date: Jun. 22, 2006

(54) Method of use data compression technology

(76) Inventor: Robert J. Biggs, Naples, FL (US)

Correspondence Address: EDWARD M. LIVINGSTON, PA, 963 TRAIL TERRACE DRIVE, NAPLES, FL, 34103, US

(21) Appl. No.: 11/315,398

(22) Filed: Dec. 21, 2005

Related U.S. Application Data
(60) Provisional application No. 60/637,785, filed on Dec. 21, 2004.

(51) Int. Cl. H04N 7/167

(52) U.S. Cl. 380/236

(57) ABSTRACT

A new method of use for compressing technology which allows for a continuous stream of data to be transmitted over pre-existing transmittal lines is described. The highly advanced data compression technology (1) allows large amounts of data, such as video data, to be compressed into small sizes. The compressed data is then sent over transmittal lines (2) and then is decompressed. The decompressed data (3) is then transmitted over a standard television (4) to allow anyone to view movies, access the Internet or utilize any other feature of the transmitted data without the use of a computer.

### CROSS REFERENCE TO RELATED APPLICATION

This application claims the benefit of U.S. Provisional Application No. 60/637,785, filed Dec. 21, 2004.

### BACKGROUND OF THE INVENTION

The present invention relates to data compression technology, more particularly, a new method of use for data compression technology.

Most people know that a standard telephone installation in the United States consists primarily of a pair of copper wires that telephone companies install in one's home or business. The copper wires allow for the transmission of various frequencies, called bandwidths. Plain Old Telephone Service or “POTS” severely limits the amount of frequencies that the switches, telephones and other equipment use. Thus, although the wires themselves have the potential to handle frequencies up to several million Hertz in most cases, POTS only utilizes the frequency range of 0 to 3,400 Hertz. Therefore, the use of such a small portion of frequencies left much room for other uses, including sending digital rather than analog data, over telephone lines. The resulting product of this progress includes the use of digital subscriber lines or “DSLs.”

Data compression is defined as the reduction of data size by reducing the number of binary bits necessary to represent the information contained within that data. Data compression has been a widely used method for sending a large amount of data over a global communication network (“Internet”) in a short period of time. In fact, data compression has been used for the transmission of bitmap picture graphics (i.e., JPEG file formats, GIF file formats, TIFF file formats, etc.), motion pictures or videos (i.e., M-JPEG file formats, MPG file formats, AVI file formats, MOV file formats, etc.) and sound files over the Internet for a significant amount of time. Although the data compression technology has allowed many to quickly, accurately and easily receive and transmit data files that were once too large to send via the Internet, the access to these files has been severely limited in scope and transmission rate.

For instance, only individuals having higher speed Internet networks, such as DSLs, can fully take advantage of data compression technology as slower speed Internet networks make the downloading and decompression of the data slow and nearly, if not, impossible. For example, using a standard modem, the data transmission speeds over telephone lines is as slow as 9600 bits per second, which is comparable to voice transmission over wireless networks such as cellular telephones. Thus, data compression technology is rarely, if ever, adequately utilized while using a standard modem as decompressing and downloading the compressed files takes a significant amount of time and buffering of the data is slow.

Recently, however, cable modems, DSLs and satellite technologies have allowed for increased data transmission of 100,000 to 1 million bits per second. In addition, the use of costly optical fiber enables data rate transmission from billions of bits per second and beyond. However, only those individuals who can afford the higher speed transmission networks may take advantage of effective data compression technology as DSL service is only available in selected areas and the equipment used to decompress the data is expensive and fiber optic cables are not currently available everywhere and the installation of such cables is expensive.

Thus, a need exists for a new method for use of data compression technology that permits the majority of individuals to utilize data compression technology without the cost of paying expensive high speed internet networks.

The relevant prior art includes the following patents:

| Patent No. | | |
|---|---|---|
| (U.S. unless | | Issue/ |
| stated otherwise) | Inventor | Publication Date |
| 5,610,916 | Kostreski et al. | Mar. 11, 1997 |
| 5,579,239 | Freeman et al. | Nov. 26, 1996 |
| 5,684,716 | Freeman | Nov. 04, 1997 |
| 5,619,183 | Ziegra et al. | Apr. 08, 1997 |
| 6,487,200 | Fraser | Nov. 26, 2002 |
| 6,011,871 | Xu | Jan. 04, 2000 |
| 6,106,570 | Mizuhara | Aug. 22, 2000 |
| 2001/0011252 | Kasahara | Aug. 02, 2001 |

### SUMMARY OF THE INVENTION

The object of the present invention is to provide a new method of use for data compression technology that is easily accessible.

Another object of the present invention is to provide a new method of use for data compression technology that is affordable.

A further object of the present invention is to provide a new method of use for data compression technology that is transferred quickly.

An even further object of the present invention is to provide a new method of use for data compression technology that is available to many.

The present invention fulfills the above and other objects by providing a new method of use for data compression technology that permits the transmission of compressed files over pre-existing telephone lines, pre-existing cable lines, satellites, high speed Internet networks and even wireless Internet networks by 1) compressing the data, 2) transmitting the compressed data over the pre-lines, satellites or Internet services and 3) decompressing the data.

Because the present invention utilizes a highly advanced data compression method that allows large amounts of data, such as video data, to be compressed into small sizes, the transmittal of this data may occur over the currently used lines and networks in a continuous stream. The continuous stream of data is then, in turn, transmitted over a standard television or computer monitor to allow anyone to view movies, access the Internet or utilize any other feature of the transmitted data without the use of a computer.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a block diagram of the present invention.

### DESCRIPTION OF THE PREFERRED EMBODIMENTS

For purposes of describing the preferred embodiment, the terminology used in reference to the numbered components in the drawings is as follows:

1. compression technology

2. transmittal line

3. decompressed data

4. television

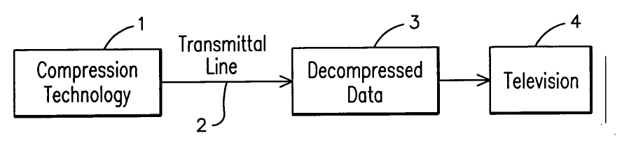

With reference to FIG. 1, a block diagram of the present invention is shown. Data is gathered from at least one global source and is compressed into smaller, transmittable data via the present invention of compression technology 1. The data is encrypted preferably using eight to sixteen bits for unique packet or data delivery or distribution either prior to or directly after compressing the data using compression technology 1. The data is then compiled in servers, ready for distribution via regular programming. In the alternative, the data may be placed on standby status, thereby awaiting a request from a subscriber for data transmission on demand. When person is ready to view the compressed data gathered from various global sources, the compressed data is transmitted over a predetermined transmittal line 2, which may be existing copper telephone lines, cable lines, satellite signals, the Internet or wireless networks, cellular telephones and other wired or wireless devices. The decompressed data 3 is then transmitted over a predetermined medium, such as a television 4, computer, cellular telephones, various wired and unwired mediums for audio and visual witnessing. Because the compression technology 1 allows for large sizes of data to be compressed into small bits, the compression technology 1 allows the compressed data 3 to be transmitted over lines not currently able to transmit data of large sizes, including video. In addition, because the data is compressed into such a small size, a continuous stream of data is transmitted over the transmittal lines 2, thereby eliminating the buffering process.

The use of the present invention will permit consumers, whether for household, commercial, industrial, governmental, educational or other purposes, receive audio, video, text, holographic and electronically projected images.

In addition, the use of the present invention may also be used for interactive applications, such as in the field of education, research, marketing, embedded advertising, branding and/or product development. To use an interactive application of the present invention, a response from an end user, such as an answer to a question posed by a teacher, an information request to a company or a purchase order to a sales department, is sent to a Network Operations Center (“NOC”), once again using advanced encryption and compression technology, to permit an entity to gather, tally, reconcile compile, assimilate, and distribute user/consumer information for marketing, research, payment, financial transactions or communications.

Although only a few embodiments of the present invention have been described in detail hereinabove, all improvements and modifications to this invention within the scope or equivalents of the claims are included as part of this invention.

Having thus described my invention, I claim:

1. A method of use for compression technology comprising the steps of:
a. gathering data from at least one source;
b. compressing said data from said at least one source;
c. transmitting said compressed data over a predetermined transmittal line;
d. decompressing said compressed data; and
e. transmitting said decompressed data over a predetermined medium.

2. The method of use for compression technology of claim 1, further comprising a step prior to step a of:
encrypting said data using 8 bit encryption.

3. The method of use for compression technology of claim 1, further comprising a step prior to step a of:
encrypting said data using 16 bit encryption.

4. The method of use for compression technology of claim 1, further comprising a step prior to step b of:
encrypting said data using 8 bit encryption.

5. The method of use for compression technology of claim 1, further comprising a step prior to step b of:
encrypting said data using 16 bit encryption.

6. The method of use for compression technology of claim 1 wherein:
said predetermined medium is a television.

7. The method of use for compression technology of claim 1 wherein:
said predetermined medium is a computer.

8. The method of use for compression technology of claim 1 wherein:
said predetermined medium is a cellular telephone.

9. The method of use for compression technology of claim 1 wherein:
said predetermined transmittal line is at least one copper telephone line.

10. The method of use for compression technology of claim 1 wherein:
said predetermined transmittal line is at least one cable line.

11. The method of use for compression technology of claim 1 wherein:
said predetermined transmittal line is at least one satellite signal.

12. The method of use for compression technology of claim 1 wherein:
said predetermined transmittal line is at least one Internet network.

13. A method of use for compression technology comprising the steps of:
a. gathering data from at least one source;
b. encrypting gathered data using 16 bit encryption;
c. compressing said data from said at least one source;
d. transmitting said compressed data over a predetermined transmittal line;
e. decompressing said compressed data; and
f. transmitting said decompressed data over a predetermined medium.

14. The method of use for compression technology of claim 13 wherein:
said predetermined transmittal line is at least one copper telephone line.

15. A method of use for compression technology comprising the steps of:
a. gathering data from at least one source;
b. compressing said data from said at least one source;
c. encrypting gathered data using 16 bit encryption;
d. transmitting said compressed data over a predetermined transmittal line;
e. decompressing said compressed data; and
f. transmitting said decompressed data over a predetermined medium.

16. The method of use for compression technology of claim 14 wherein:
said predetermined transmittal line is at least one copper telephone line.
